(19) United States
(12) Patent Application Publication
(10) Pub. No.: US 2019/0095866 A1
(43) Pub. Date: Mar. 28, 2019

(54) METHOD AND DEVICE FOR PROCESSING MAIL DATA

(71) Applicant: BEIJING GRIDSUM TECHNOLOGY CO., LTD., Haidian District Beijing (CN)

(72) Inventors: Guosheng Qi, Haidian District Beijing (CN); Jibin Yang, Haidian District Beijing (CN); Chong Wu, Haidian District Beijing (CN)

(21) Appl. No.: 16/081,323

(22) PCT Filed: Mar. 1, 2017
(86) PCT No.: PCT/CN2017/075321

§ 371 Date: Aug. 30, 2018

(30) Foreign Application Priority Data
Mar. 1, 2016 (CN) 201610116788.1

(51) Int. Cl. G06Q 10/10; G06Q 30/02; H04L 12/58; H04L 29/08

(52) U.S. Cl. CPC G06Q 10/107; G06Q 30/0201; H04L 67/22; H04L 51/34; G06Q 30/0239

(57) ABSTRACT

Disclosed are a method and device for processing mail data. The method includes: a mail carrying a web page link for mail promotion is sent to a target mailbox; an operating behavior regarding the mail carrying the web page link in the target mailbox is monitored, so as to obtain operating behavior data; a mail sending policy is determined according to the operating behavior data, wherein the mail sending policy is a pre-created policy for sending a mail; and the mail carrying the web page link for mail promotion is sent to the target mailbox according to the mail sending policy. The disclosure solves the technical problem in the related art of poor conversion effect due to unitary mail contents and sending.

### TECHNICAL FIELD

The present disclosure relates to the field of data processing, and more particularly to a method and device for processing mail data.

### BACKGROUND

Email Direct Marketing (EDM) is a common digital marketing mode of a business company, which sends a mail to a target user for marketing so as to attract audiences for interaction and subsequent conversion. However, the inventor discovers that in the related EDM a promotion mail is sent to a user in a unified manner, and an expected conversion effect cannot be achieved due to unitary mail contents and sending policies.

Any effective solution has not been proposed yet at present for the above-mentioned problem.

### SUMMARY

The embodiments of the present disclosure provide a method and device for processing mail data, used to at least solve the technical problem in the related art of poor conversion effect due to unitary mail contents and sending.

According to one aspect of the embodiments of the present disclosure, a method for processing mail data is provided, comprising: monitoring an operating behavior regarding a mail carrying a web page link in a target mailbox, as to obtain operating behavior data; determining a mail sending policy according to the operating behavior data, wherein the mail sending policy is a pre-created policy for sending a mail; and sending a mail carrying a web page link for mail promotion to the target mailbox according to the mail sending policy.

According to another embodiment, the method further comprising: acquiring an identification parameter, carried in the web page link, for identifying the target mailbox; associating the operating behavior data with the target mailbox by utilizing the identification parameter, and establishing an association relationship; acquiring user information corresponding to the target mailbox; and classifying the operating behavior data according to the user information, and analyzing a conversion result of the mail promotion on a user group.

According to another embodiment, the method further comprising: determining the operating behavior regarding the mail carrying the web page link in the target mailbox, wherein determining the operating behavior regarding the mail carrying the web page link in the target mailbox comprises: monitoring whether a preset request is received, wherein when the mail is opened, the preset request is sent to request for a hidden picture pre-added into the mail; and when the preset request is monitored, determining the operating behavior, wherein the operating behavior at least comprises: an operation of opening the mail carrying the web page link in the target mailbox, and an operation of clicking the web page link in the mail carrying the web page link in the target mailbox.

According to another embodiment, after sending the mail carrying the web page link for mail promotion to the target mailbox according to the mail sending policy, the method further comprising: monitoring an operating behavior regarding the mail carrying the web page link for the mail promotion, as to obtain operating behavior data regarding the mail carrying the web page link for the mail promotion; updating the mail sending policy according to the operating behavior data; and sending the mail carrying a web page link for mail promotion to the target mailbox according to the updated mail sending policy.

According to another embodiment, determining the mail sending policy according to the operating behavior data comprises: selecting a first sending policy when the mail is opened but the web page link is not clicked, wherein the first sending policy is: sending a content-adjusted mail to the target mailbox; and selecting a second sending policy when the web page link is clicked but not to jump to a web page, wherein the second sending policy is: re-sending the mail to the target mailbox, wherein sending the mail carrying the web page link for mail promotion to the target mailbox according to the updated mail sending policy comprises: adjusting content of the mail; and sending a content-adjusted mail to the target mailbox.

According to another aspect of the present disclosure, a device for processing mail data is provided, comprising: a monitoring unit, configured to monitor an operating behavior regarding a mail carrying a web page link in a target mailbox, so as to obtain operating behavior data; a first determination unit, configured to determine a mail sending policy according to the operating behavior data, wherein the mail sending policy is a pre-created policy for sending a mail; and a sending unit, configured to send a mail carrying a web page link for mail promotion to the target mailbox according to the mail sending policy.

According to another embodiment, the device further comprising: a first acquisition unit, configured to acquire an identification parameter, carried in the web page link, for identifying the target mailbox; an association unit, configured to associate the operating behavior data with the target mailbox by utilizing the identification parameter, and establish an association relationship; a second acquisition unit, configured to acquire user information corresponding to the target mailbox; and an analysis unit, configured to classify the operating behavior data according to the user information, and analyze a conversion result of mail promotion on a user group.

According to another embodiment, the device further comprising: a second determination unit, configured to determine the operating behavior regarding the mail carrying the web page link in the target mailbox, wherein the second determination unit comprises: a monitoring module, configured to monitor whether a preset request is received, wherein when the mail is opened, the preset request is sent to request for a hidden picture pre-added into the mail; and a determination module, configured to determine the operating behavior when the preset request is monitored, wherein the operating behavior at least comprises: an operation of opening the mail carrying the web page link in the target mailbox, and an operation of clicking the web page link in the mail carrying the web page link in the target mailbox.

According to another embodiment, the monitoring unit is further configured to monitor, after sending the mail carrying the web page link for mail promotion to the target mailbox according to the mail sending policy, an operating behavior regarding the mail carrying the web page link for mail promotion, so as to obtain operating behavior data regarding the mail carrying the web page link for mail promotion; the first determination unit is further configured to update the mail sending policy according to the operating behavior data; and the sending unit is further configured to send the mail carrying a web page link for mail promotion to the target mailbox according to the updated mail sending policy.

According to another embodiment, the first determination unit comprises: a first selection module, configured to select a first sending policy when the mail is opened but the web page link is not clicked, wherein the first sending policy is: sending a content-adjusted mail to the target mailbox; and a second selection module, configured to select a second sending policy when the web page link is clicked but not to jump to a web page, wherein the second sending policy is: re-sending the mail to the target mailbox; and the sending unit comprises: an adjustment module, configured to adjust content of the mail; and a sending module, configured to send a content-adjusted mail to the target mailbox.

In the embodiments of the present disclosure, in a mail promotion process, a mail sending policy may be determined according to monitored operating behavior data, a mail is further sent. An operating behavior may be monitored every time the mail is sent, and then a corresponding mail sending policy is determined, so that mail sending can be continuously optimized to form a continuous optimization closed loop. Compared with the related art in which a mail is sent only once or sent repeatedly in a unified manner, the present disclosure can continuously optimize mail sending, so as to continuously optimize a mail conversion effect, and the technical problem in the related art of poor conversion effect due to unitary mail contents and sending is solved, thereby improving the promoted mail conversion effect.

### BRIEF DESCRIPTION OF THE DRAWINGS

The drawings illustrated herein are intended to provide a further understanding for the present disclosure, and form a part of the present disclosure. The schematic embodiments and illustrations of the present disclosure are intended to explain the present disclosure, and do not form improper limits to the present disclosure. In the drawings:

FIG. 1 is a flowchart of a method for processing mail data according to a first embodiment of the present disclosure;

FIG. 2-1 is a flowchart of a method for processing mail data according to a second embodiment of the present disclosure;

FIG. 2-2 is a flowchart of analysis of a conversion result of mail promotion according to an embodiment of the present disclosure; and

FIG. 3 is a schematic diagram of a device for processing mail data according to an embodiment of the present disclosure.

### DETAILED DESCRIPTION OF THE EMBODIMENTS

In order to make those skilled in the art better understand the solutions of the present disclosure, the technical solutions in the embodiments of the present disclosure will be clearly and completely described below in conjunction with the drawings in the embodiments of the present disclosure. Obviously, the described embodiments are only a part of the embodiments of the present disclosure, not all of the embodiments. On the basis of the embodiments of the present disclosure, all other embodiments obtained on the premise of no creative work of those skilled in the art shall fall within the scope of protection of the present disclosure.

It should be noted that the description and claims of the present disclosure and terms “first”, “second” and the like in the drawings are used to distinguish similar objects, and do not need to describe a specific sequence or a precedence order. It will be appreciated that data used in such a way may be exchanged under appropriate conditions, in order that the embodiments of the present disclosure described here can be implemented in a sequence except sequences graphically shown or described here. In addition, terms “include” and “have” and any inflexions thereof are intended to cover non-exclusive inclusions. For example, processes, methods, systems, products or equipment containing a series of steps or units do not need to clearly show those steps or units, and may include other inherent steps or units of these processes, methods, products or equipment, which are not clearly shown instead.

According to the embodiments of the present disclosure, a method embodiment for a method for processing mail data is provided. It should be noted that the steps shown in the flowchart of the drawings may be executed in a computer system including, for example, a set of computer-executable instructions. Moreover, although a logic sequence is shown in the flowchart, the shown or described steps may be executed in a sequence different from the sequence here under certain conditions.

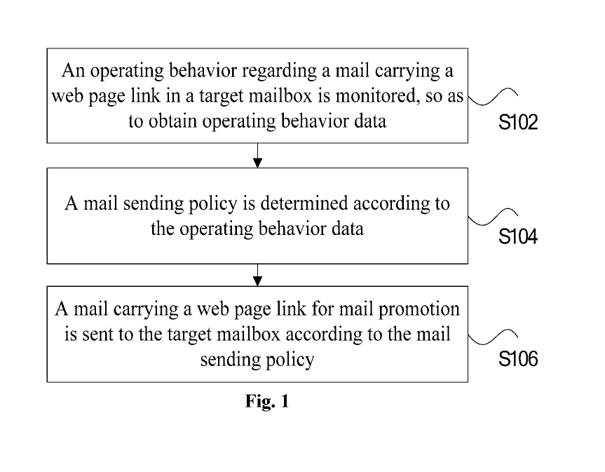

FIG. 1 is a flowchart of a method for processing mail data according to a first embodiment of the present disclosure. As shown in FIG. 1, the method includes the steps as follows.

In step S102, an operating behavior regarding a mail carrying a web page link in a target mailbox is monitored, so as to obtain operating behavior data.

Before an operating behavior regarding a mail is monitored, a mail carrying a web page link for mail promotion is sent to a target mailbox, and the mail carrying the web page link for mail promotion is sent to the target mailbox according to an initial sending policy, wherein the initial sending policy is: sending the mail by using a sending system or a server default sending manner, that is, sending the mail on sending time and/or a link address randomly.

In the embodiments of the present disclosure, a mailbox pool is provided for storing a series of target mailboxes, wherein a mailbox corresponds to a user. The mailbox pool may further contain user information about mailbox owners (namely users corresponding to mailboxes) such as name, sex, age and vocation. The mailbox pool provided in the present disclosure may be correspondingly connected with a Customer Relation Management (CRM) system, in order to update mailboxes in the mailbox pool.

In the present embodiment, a mailbox address of a target mailbox is acquired from the mailbox pool, and a corresponding mail is sent, wherein the mail carries a web page link for mail promotion. After receiving the mail, a user corresponding to the target mailbox may open the mail, click the web page link in the mail, and generate operations such as subsequent conversion.

In the present embodiment, user operating behaviors are monitored, the operating behaviors may be divided in advance into mail opening, web page link clicking, jumping to a wet page, registry and login and the like, these operating behaviors are monitored to obtain operating behavior data, and the operating behavior data may reflect operating behaviors made by the user. These operating behaviors can reflect an attitude of the user for the mail. For example, when the user opens the mail but does not click the web page link, it may be shown that the contents of the mail are not attractive enough to the user. When the user clicks the web page link but does not perform registry, it is shown that the user is interested but does not decide whether to know more.

In step S104, a mail sending policy is determined according to the operating behavior data.

Herein, the mail sending policy is a pre-created policy for sending the mail, wherein the mail sending policy may at least comprises sending time, a web page link address and the like.

Because different operating behaviors of a user can reflect an attitude of the user for the content of a mail or the content of a web page corresponding to a web page link, a mail sending policy may be determined according to the operating behavior data reflecting the operating behaviors of the user after monitoring the operating behaviors of the user.

After the user receives mails, not all of the mails are converted finally. In the present embodiment, a corresponding mail sending policy is determined by means of monitored operating behaviors, in order to re-send a mail according to the operating behaviors to make it converted finally.

The mail sending policy in the present disclosure may be preset and stored according to different behavior attitudes of the user, wherein different operating behaviors correspond to different mail sending policies, that is, a corresponding relationship exists between mail sending policies and operating behaviors.

In step S106, the mail carrying the web page link for mail promotion is sent to the target mailbox according to the mail sending policy.

After a corresponding mail sending policy is determined, a mail is sent to the target mailbox according to the mail sending policy.

It should be noted that in the embodiments of the present disclosure, in a mail promotion process, a mail sending policy may be determined according to monitored operating behavior data, a mail is further sent. An operating behavior may be monitored every time the mail is sent, and then a corresponding mail sending policy is determined, so that mail sending can be continuously optimized to form a continuous optimization closed loop. Compared with the related art in which a mail is sent once or sent repeatedly in a unified manner, the present disclosure can continuously optimize mail sending, so as to continuously optimize a mail conversion effect, and the technical problem in the related art of poor conversion effect due to unitary mail content and sending is solved, thereby improving the promoted mail conversion effect.

In an example embodiment, a monitoring code may be embedded into a sent mail to monitor operating behaviors such as mail opening and clicking, and a certain identifier (Cookie is a mode, but the disclosure is not limited to this mode) is added to a mail receiving client when the mail is opened and clicked, in order to perform subsequent data analysis. Different operating behaviors may adopt different monitoring modes and set different monitoring codes, and a set of monitoring codes may be adopted to monitor operating behaviors in the whole conversion process.

In an example embodiment, an identification parameter edmid for representing a target mailbox is carried in the web page link, wherein the identification parameter may be used to uniquely identify a corresponding mailbox, in order to record the subsequent conversion situation of each mailbox during subsequent monitoring of the operating behaviors and recording of the operating behavior data.

In an example embodiment, the method further includes the steps as follows. An identification parameter, carried in the web page link, for representing the target mailbox is acquired. The operating behavior data is associated with the target mailbox by utilizing the identification parameter, and an association relationship is established. User information corresponding to the target mailbox is acquired. The operating behavior data is classified according to the user information, and a conversion result of the mail promotion on a user group is analyzed.

In the present embodiment, because an identification parameter representing a target mailbox is carried in a web page link, the identification parameter may be utilized to connect a series of behavior data including mail opening, clicking, website arrival and conversion generation of a user corresponding to the same mailbox having the identification parameter, and establishes association between the series of behavior data and the mailbox, so that a series of data may be obtained by statistics to evaluate a mail marketing effect. Meanwhile, in the presence of the identification parameter edmid, this series of operating behaviors may be connected with user information about each mailbox owner in a mailbox pool in series to further improve a mail promotion conversion effect on different user groups of different sexes, ages and vocation personnel, and the present process and the final stage of each mailbox owner may be analyzed. It should be noted that analysis of the mail promotion conversion effect may refer to: after the operating behavior data is monitored, the operating behavior data is directly analyzed, or the monitored operating behavior data may be analyzed according to a preset period, which will not be limited in the embodiments of the present disclosure.

In an example embodiment, the method further includes the steps as follows. An operating behavior regarding a mail carrying a web page link in a target mailbox is determined. In an example embodiment, the step that an operating behavior regarding a mail carrying a web page link in a target mailbox is determined includes the sub-step as follows. It is monitored whether a preset request is received, wherein when the mail is opened, a preset request is sent to request for a hidden picture pre-added into the mail. When the preset request is monitored, the operating behavior is determined, wherein the operating behavior at least comprises: an operation of opening a mail carrying a web page link in a target mailbox, and an operation of clicking a link in a mail carrying a web page link in a target mailbox.

In the present embodiment, during generation of a mail, an invisible picture namely hidden picture is added into the mail, and codes are written to trigger a preset request requesting for the hidden picture when a user opens the mail or clicks a link in the mail carrying a web page link in a target mailbox. Thus, whether an operating behavior regarding mail opening happens can be determined by monitoring whether the preset request is received, monitoring is convenient and accurate, and due to invisibility of the hidden picture, user experience will not be influenced.

In an example embodiment, after the mail carrying the web page link for mail promotion is sent to the target mailbox according to the mail sending policy, the method further includes the steps as follows. An operating behavior regarding the mail carrying the web page link for mail promotion is monitored, so as to obtain operating behavior data regarding the mail carrying the web page link for mail promotion. The mail sending policy is updated according to the operating behavior data. A mail carrying a web page link for mail promotion is sent to a target mailbox according to the updated mail sending policy.

After the mail is sent based on the mail sending policy, an operating behavior regarding the mail is continuously monitored to obtain corresponding operating behavior data, and the mail sending policy is updated according to the operating behavior data, in order to send the mail to the target mailbox based on the updated mail sending policy. In the present embodiment, a mail conversion effect is optimized by updating the mail sending policy and optimizing the mail sending policy.

In an example embodiment, the step that a mail sending policy is determined according to the operating behavior data includes the sub-steps as follows. If the mail is opened but the web page link is not clicked, a first sending policy is selected, wherein the first sending policy is: sending a content-adjusted mail to the target mailbox. If the web page link is clicked but not to jump to a web page, a second sending policy is selected, wherein the second sending policy is: re-sending the mail to the target mailbox. The step that a mail carrying a web page link for mail promotion is sent to a target mailbox according to the updated mail sending policy includes the sub-steps as follows. The content of the mail are adjusted. The content-adjusted mail is sent to the target mailbox.

In the present embodiment, after operating behavior data is obtained, the operating behavior data is analyzed to determine the operating conversion situation of each mail. When the mail is opened but the web page link is not clicked, it is shown that the content of the mail is not attractive enough to the user. In this case, a first sending policy (one of mail sending policies, a second sending policy mentioned below is also one of mail sending policies, which will not be elaborated) may be selected. Under this policy, the content of the mail is re-adjusted. For example, more attractive contents of a mail are provided, and sending of the content-adjusted mail to the same target mailbox is triggered again. When the mailbox of the user receives the mail again, the web page link may be clicked when the content of the mail is attractive, and subsequent conversion may be performed.

In an example embodiment, the step that a mail sending policy is determined according to the operating behavior data includes the sub-steps as follows. If the web page link is clicked but not to jump to a web page, a second sending policy is selected, wherein the second sending policy is: re-sending the mail to the target mailbox. The step that a mail carrying a web page link for mail promotion is sent to a target mailbox according to the updated mail sending policy includes the sub-steps as follows. The mail is continuously sent to the target mailbox.

In the present embodiment, after operating behavior data is obtained, the operating behavior data is analyzed to determine the operating conversion situation of each mail. When the web page link is clicked but does not jumps to the web page, that is, effective conversion is not formed, a second sending policy may be selected to send the same mail to the user again, so that exposure is continued until conversion is successful.

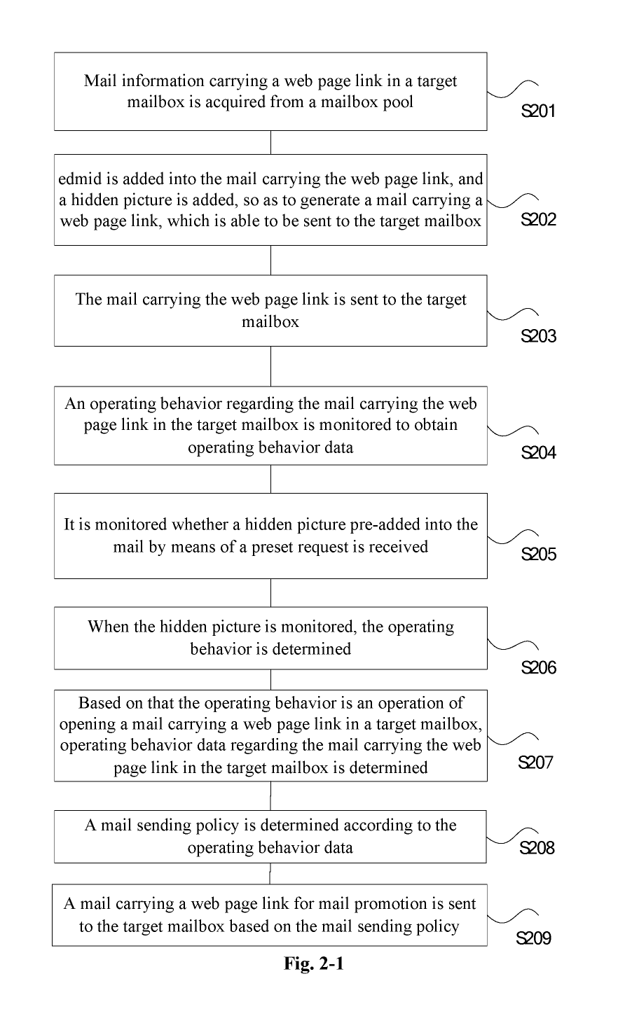

The embodiments of the present disclosure provide another implementation manner for a method for processing mail data. Firstly, it is assumed that an executive subject of the present embodiment is a mail sending server, and then as shown in FIG. 2-1 and FIG. 2-2, the method includes the steps as follows.

In step S201, mail information carrying a web page link in a target mailbox is acquired from a mailbox pool.

Herein, the mail information may at least comprises a mailbox address and user information about a mail carrying the web page link, and a unique identification parameter (this identification parameter is expressed as edmid) is set for each mailbox address, the identification parameter being used to uniquely identify a target mailbox and perform subsequent conversion tracking on all items of associated data generated by the target mailbox.

In step S202, edmid is added into the mail carrying the web page link, and a hidden picture is added, so as to generate a mail carrying a web page link, which can be sent to the target mailbox.

It should be noted that step S202 of adding edmid into the mail carrying the web page link and adding a hidden picture is used for monitoring an operating behavior of a user regarding the mail, a hidden text or a hidden media file may also be added, and the present disclosure does not limit this.

In step S203, the mail carrying the web page link is sent to the target mailbox. The above steps S201 to S203 are set for the mail sending server to send a web page link to a client.

Further, in the following steps S204 to S209, a mail sending policy is optimized based on an acquired operating behavior of the client regarding the mail carrying the web page link, and a mail carrying a web page link for mail promotion is sent to the target mailbox by utilizing the optimized mail sending policy.

In step S204, an operating behavior regarding the mail carrying the web page link in the target mailbox is monitored to obtain operating behavior data.

Herein, the operating behavior may include an operation of mail opening, an operation of web page link clicking, an operation of web page arrival, an operation of a user on a web page and the like.

In an example embodiment, monitoring an operating behavior includes: recording an operation of mail opening, wherein when opening a mail, a mail receiver will request for an invisible picture, so as to record this opening operation, and an identifier of a client (the identifier of the client is expressed as rId) is added; recording an operation of web page link clicking and an operation of web page arrival, wherein when clicking a link in the mail, the mail receiver will enter a corresponding website, and in this case, the link of a landing page may contain a parameter edmid; and recording an operation of a user on a web page, wherein subsequent operations of the mail receiver on the website will be monitored and recorded, and will also be corresponded to edmld and rID.

In step S205, it is monitored whether a hidden picture pre-added into the mail by means of a preset request is received.

In step S206, when the hidden picture is monitored, the operating behavior is determined, wherein it is assumed that the operating behavior is an operation of opening a mail carrying a web page link in a target mailbox.

In step S207, based on that the operating behavior is an operation of opening a mail carrying a web page link in a target mailbox, operating behavior data regarding the mail carrying the web page link in the target mailbox is determined.

In step S208, a mail sending policy is determined according to the operating behavior data.

In step S209, a mail carrying a web page link for mail promotion is sent to the target mailbox based on the mail sending policy.

Further, the above steps S204 to S209 are equivalent to one optimization process of a mail sending policy, user operating behaviors may be analyzed, and the mail sending policy is updated according to an analysis result. Step S204 is returned, in order to send the mail again. Specifically, subsequent user behaviors are analyzed, in order to perform subsequent marketing.

Alternatively, the embodiments of the present disclosure may also analyze conversion results of different user groups for mail promotion, so as to analyze conversion situations of different user groups. On one hand, the analysis process may be executed after monitoring operating behavior data. Because it is necessary to repeatedly optimize the mail sending policy in the embodiments of the present disclosure, this process will repeatedly many times monitor an operating behavior of a user. Therefore, the conversion situations of different user groups may be analyzed every time the operating behavior is monitored. On the other hand, the analysis process may also refer to: analyzing operating behavior data according to a preset period. The first situation is taken as an example for further description below. Specifically, after step S204, referring to FIG. 2-2, the method further includes the steps as follows.

In step S210, an identification parameter edmid, carried in the web page link, for representing the target mailbox is acquired.

In step S211, the operating behavior data is associated with the target mailbox by utilizing the identification parameter, and an association relationship is established.

In step S212, user information corresponding to the target mailbox is acquired.

In step S213, the operating behavior data is classified according to the user information, and a conversion result of a user group for mail promotion is analyzed.

The above steps S210 to S213 may be executed after step S204 or before step S201 or after step S209. The present disclosure does not specifically limit the execution order.

In the present embodiment, because an identification parameter representing a target mailbox is carried in a web page link, the identification parameter may be utilized to connect a series of behavior data including mail opening, clicking, website arrival and conversion generation of a user corresponding to the same mailbox having the identification parameter, and to establish association between the series of behavior data and the mailbox, so that a series of data may be obtained by statistics to evaluate a mail marketing effect. Meanwhile, in the presence of the identification parameter edmid, this series of operating behaviors may be connected with user information about each mailbox owner in a mailbox pool in series to further improve a mail promotion conversion effect on different user groups of different sexes, ages and vocation personnel, and the present process and the final stage of each mailbox owner can be analyzed.

In the present embodiment, in a mail promotion process, a mail sending policy may be determined according to monitored operating behavior data, a mail is sent again, an operating behavior may be monitored every time the mail is sent, and then a corresponding mail sending policy is determined, so that mail sending can be continuously optimized to form a continuous optimization closed loop.

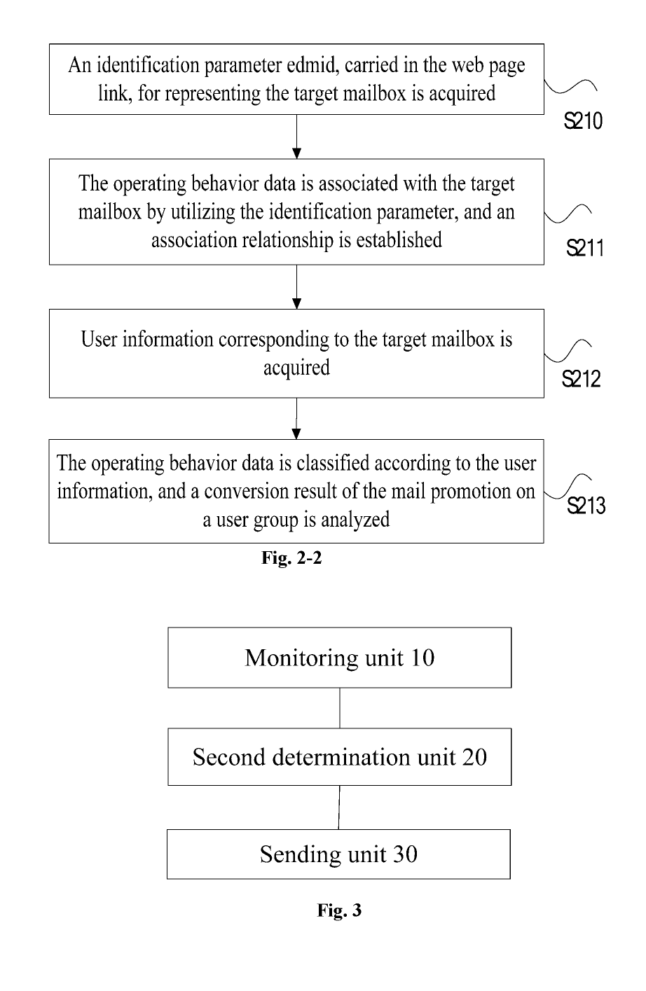

The embodiments of the present disclosure also provide a device for processing mail data. The device may be configured to execute the method for processing the mail data in the embodiments of the present disclosure. As shown in FIG. 3, the device includes: a monitoring unit 10, a first determination unit 20 and a sending unit 30.

The monitoring unit 10 is configured to monitor an operating behavior regarding a mail carrying a web page link in a target mailbox, so as to obtain operating behavior data.

Before an operating behavior regarding a mail is monitored, a mail carrying a web page link for mail promotion is sent to a target mailbox, and the mail carrying the web page link for mail promotion is sent to the target mailbox according to an initial sending policy, wherein the initial sending policy is: sending the mail by using a sending system or a server default sending manner, that is, sending the mail on sending time and/or a link address randomly.

In the embodiments of the present disclosure, a mailbox pool is provided for storing a series of target mailboxes, wherein a mailbox corresponds to a user. The mailbox pool may further contain user information about mailbox owners (namely users corresponding to mailboxes) such as name, sex, age and vocation. The mailbox pool provided in the present disclosure may be correspondingly connected with a Customer Relation Management (CRM) system, in order to update mailboxes in the mailbox pool.

In the present embodiment, a mailbox address of a target mailbox is acquired from the mailbox pool, and a corresponding mail is sent, wherein the mail carries a web page link for mail promotion. After receiving the mail, a user corresponding to the target mailbox may open the mail, click the web page link in the mail, and generate operations such as subsequent conversion.

In the present embodiment, user operating behaviors are monitored, the operating behaviors may be divided in advance into mail opening, web page link clicking, jumping to a wet page, registry and login and the like, these operating behaviors are monitored to obtain operating behavior data, and the operating behavior data may reflect operating behaviors made by the user. These operating behaviors can reflect an attitude of the user for the mail. For example, when the user opens the mail but does not click the web page link, it may be shown that the contents of the mail are not attractive enough to the user. If the user clicks the web page link but does not perform registry, it is shown that the user is interested but does not decide whether to know more.

The first determination unit 20 is configured to determine a mail sending policy according to the operating behavior data.

Herein, the mail sending policy is a pre-created policy for sending the mail, wherein the mail sending policy may at least contain sending time, a web page link address and the like.

Because different operating behaviors of a user can reflect an attitude of the user for the contents of a mail or the content of a web page corresponding to a web page link, a mail sending policy may be determined based on the operating behavior data reflecting the operating behaviors of the user after monitoring the operating behaviors of the user. After the user receives mails, not all of the mails are converted finally. In the present embodiment, a corresponding mail sending policy is determined by means of monitored operating behaviors, in order to re-send a mail according to the operating behaviors to make it converted finally.

The mail sending policy in the present disclosure may be preset and stored according to different behavior attitudes of the user, wherein different operating behaviors correspond to different mail sending policies, that is, a corresponding relationship exists between mail sending policies and operating behaviors.

The sending unit 30 is configured to send the mail carrying the web page link for mail promotion to the target mailbox based on the mail sending policy.

After a corresponding mail sending policy is determined, a mail is sent to the target mailbox according to the mail sending policy.

It should be noted that in the embodiments of the present disclosure, in a mail promotion process, a mail sending policy may be determined according to monitored operating behavior data, a mail is further sent. An operating behavior may be monitored every time the mail is sent, and then a corresponding mail sending policy is determined, so that mail sending can be continuously optimized to form a continuous optimization closed loop. Compared with the related art in which a mail is sent only once or sent repeatedly in a unified manner, the present disclosure can continuously optimize mail sending, so as to continuously optimize a mail conversion effect, and the technical problem in the related art of poor conversion effect due to unitary mail contents and sending is solved, thereby improving the promoted mail conversion effect.

In an example embodiment, a monitoring code may be embedded into a sent mail to monitor operating behaviors such as mail opening and clicking, and a certain identifier (Cookie is a mode, but the disclosure is not limited to this mode) is added to a mail receiving client when the mail is opened and clicked, in order to perform subsequent data analysis. Different operating behaviors may adopt different monitoring modes and set different monitoring codes, and a set of monitoring codes may be adopted to monitor operating behaviors in the whole conversion process.

In an example embodiment, an identification parameter edmid for representing a target mailbox is carried in the web page link, wherein the identification parameter may be used to uniquely identify a corresponding mailbox, in order to record the subsequent conversion situation of each mailbox during subsequent monitoring of the operating behaviors and recording of the operating behavior data.

In an example embodiment, the device further includes a: a first acquisition unit, configured to acquire an identification parameter, carried in the web page link, for representing the target mailbox; an association unit, configured to associate the operating behavior data with the target mailbox by utilizing the identification parameter, and establish an association relationship; a second acquisition unit, configured to acquire user information corresponding to the target mailbox; and an analysis unit, configured to classify the operating behavior data according to the user information, and analyze a conversion result of a user group for mail promotion.

Here, it should be noted that the monitoring unit 10, the first determination unit 20 and the sending unit 30 may be operated in a computer terminal by serving as a part of the device. Functions implemented by the above-mentioned modules may be executed by means of a processor in the computer terminal. The computer terminal may also be terminal equipment such as a smart phone (Android phone, iOS phone or the like), a tablet computer, a palmtop, Mobile Internet Devices (MIDs) and a PAD.

In the present embodiment, because an identification parameter representing a target mailbox is carried in a web page link, the identification parameter may be utilized to connect a series of behavior data including mail opening, clicking, website arrival and conversion generation of a user corresponding to the same mailbox having the identification parameter, and to establish association between the series of behavior data and the mailbox, so that a series of data may be obtained by statistics to evaluate a mail marketing effect. Meanwhile, in the presence of the identification parameter edmid, this series of operating behaviors may be connected with user information about each mailbox owner in a mailbox pool in series to further improve a mail promotion conversion effect on different user groups of different sexes, ages and vocation personnel, and the present process and the final stage of each mailbox owner can be analyzed. It should be noted that analysis of the mail promotion conversion effect may refer to: after the operating behavior data is monitored, the operating behavior data is directly analyzed, or the monitored operating behavior data may be analyzed according to a preset period, which will not be limited in the embodiments of the present disclosure.

In an example embodiment, the device further includes: a second determination unit, configured to determine an operating behavior regarding a mail carrying a web page link in a target mailbox. The second determination unit includes: a monitoring module, configured to monitor whether a preset request is received, wherein when the mail is opened, a preset request is sent to request for a hidden picture pre-added into the mail; and a determination module, configured to determine, when monitoring the preset request, the operating behavior, wherein the operating behavior at least contains: an operation of opening a mail carrying a web page link in a target mailbox, and an operation of clicking a link in a mail carrying a web page link in a target mailbox.

In the present embodiment, during generation of a mail, an invisible picture namely hidden picture is added into the mail, and codes are written to trigger a preset request requesting for the hidden picture when a user opens the mail or clicks a link in the mail carrying a web page link in a target mailbox. Thus, whether an operating behavior regarding mail opening happens can be determined by monitoring whether the preset request is received, monitoring is convenient and accurate, and due to invisibility of the hidden picture, user experience will not be influenced.

In an example embodiment, the monitoring unit is further configured to monitor, after sending the mail carrying the web page link for mail promotion to the target mailbox based on the mail sending policy, an operating behavior regarding the mail carrying the web page link for mail promotion, so as to obtain operating behavior data regarding the mail carrying the web page link for mail promotion. The first determination unit is further configured to update the mail sending policy according to the operating behavior data. The sending unit is further configured to send a mail carrying a web page link for mail promotion to a target mailbox based on the updated mail sending policy.

After the mail is sent according to the mail sending policy, an operating behavior regarding the mail is continuously monitored to obtain corresponding operating behavior data, and the mail sending policy is updated according to the operating behavior data, in order to send the mail to the target mailbox based on the updated mail sending policy. In the present embodiment, a mail conversion effect is optimized by updating the mail sending policy and optimizing the mail sending policy.

In an example embodiment, the first determination unit includes: a first selection module, configured to select, if the mail is opened but the web page link is not clicked, a first sending policy, wherein the first sending policy is: sending a content-adjusted mail to the target mailbox; and a second selection module, configured to select, if the web page link is clicked but not to jump to a web page, a second sending policy, wherein the second sending policy is: re-sending the mail to the target mailbox. The sending unit includes: an adjustment module, configured to adjust the contents of the mail; and a first sending module, configured to send the content-adjusted mail to the target mailbox.

In the present embodiment, after operating behavior data is obtained, the operating behavior data is analyzed to determine the operating conversion situation of each mail. When the mail is opened but the web page link is not clicked, it is shown that the contents of the mail are not attractive enough to the user. In this case, a first sending policy (one of mail sending policies, a second sending policy mentioned below is also one of mail sending policies, which will not be elaborated) may be selected. Under this policy, the contents of the mail are re-adjusted. For example, more attractive content of a mail is provided, and sending of the content-adjusted mail to the same target mailbox is triggered again. When the mailbox of the user receives the mail again, the web page link may be clicked when the contents of the mail are attractive, and subsequent conversion may be performed.

In an example embodiment, the first determination unit includes: a second selection module, configured to select, if the web page link is clicked but not to jump to a web page, a second sending policy, wherein the second sending policy is: re-sending the mail to the target mailbox. The sending unit includes: a second sending module, configured to continuously send the mail to the target mailbox.

In the present embodiment, after operating behavior data is obtained, the operating behavior data is analyzed to determine the operating conversion situation of each mail. When the web page link is clicked but does not jumps to the web page, that is, effective conversion is not formed, a second sending policy may be selected to send the same mail to the user again, so that exposure is continued until conversion is successful.

The embodiments of the present disclosure also provide an alternative device for processing mail data, specifically including: a mailbox pool, a mail sending module, a mail monitoring module, a conversion monitoring module, a data analysis module, a subsequent marketing module, and a mail marketing optimization module, wherein the mail sending module is equivalent to the sending unit in the above-mentioned embodiments of the present disclosure; the mail monitoring module and the conversion monitoring module are equivalent to the monitoring unit in the above-mentioned embodiments of the present disclosure; the data analysis module is equivalent to the analysis unit in the above-mentioned embodiments of the present disclosure; and the subsequent marketing module and the mail marketing optimization module are equivalent to the first determination unit in the above-mentioned embodiments of the present disclosure. Functions of each module will be introduced below respectively.

The mailbox pool is configured to store a series of target mailboxes, wherein a mailbox corresponds to a user. The mailbox pool may further contain user information about mailbox owners (namely users corresponding to mailboxes) such as name, sex, age and vocation. The mailbox pool provided in the present disclosure may be correspondingly connected with a CRM system, in order to update mailboxes in the mailbox pool.

The mail sending module is correspondingly connected with the mailbox pool, and acquires a mailbox from the mailbox pool. The mail carries a web page link for mail promotion. After receiving the mail, a user corresponding to a target mailbox may open the mail, click the web page link in the mail, and generate operations such as subsequent conversion. A mailbox identification parameter edmid will be added to the web page link and used to uniquely identify the mailbox and perform subsequent conversion tracking.

The mail monitoring module is configured to monitor, by embedding a monitoring code into a mail, operating behaviors such as mail opening and clicking, and add a certain identifier (Cookie is a mode, but the disclosure is not limited to this mode) to a mail receiving client when the mail is opened and clicked, in order to perform subsequent data analysis. Different operating behaviors may adopt different monitoring modes and set different monitoring codes, and a set of monitoring codes may be adopted to monitor operating behaviors in the whole conversion process.

After clicking the mail, the user will enter a corresponding website, subsequent conversion behaviors such as purchasing and registry may be generated, the conversion monitoring module monitors the conversion behaviors, and the conversion behaviors may acquire edmid added to the link clicked to be entered and an identifier added by the mail monitoring module.

According to the data analysis module, by connecting a series of behavior data including mail opening, clicking, website arrival and conversion generation in series, a series of data may be obtained by statistics to evaluate a mail marketing effect. In the presence of edmid, this series of behaviors may be connected with background information about each mailbox owner in the mailbox pool in series. Generally speaking, the effects for different sexes, ages and vocation personnel caused by the present mail marketing may be evaluated. Individually speaking, the present process and the final stage of each mailbox owner can be analyzed.

The subsequent marketing module performs different types of subsequent marketing for different behaviors of different mailbox owners. For example, the content of the mail is adjusted for a user who opens the mail but does not click the mail, and a more attractive mail is provided and sent again. It is considered to continuously expose a user who clicks the mail but does not generate subsequent conversion, and to optimize a conversion path.

The mail marketing optimization module continuously optimizes subsequent mail marketing contents and modes for different types of users by making statistics on the effects for different sexes, ages and vocation personnel caused by the present mail marketing, so as to form a mail marketing system in an automated continuous feedback type.

Each function unit provided by the embodiment of the present disclosure may be operated in a mobile terminal, a computer terminal or a similar operating device, or may be stored as a part of a storage medium.

Hereupon, the embodiment of the disclosure may provide a computer terminal, and the computer terminal may be any computer terminal equipment in a computer terminal group. Alternatively, in the present embodiment, the computer terminal may also be replaced with terminal equipment such as a mobile terminal.

Alternatively, in the present embodiment, the computer terminal may be located on at least one piece of network equipment in multiple pieces of network equipment of a computer network.

In the present embodiment, the computer terminal may execute program codes of the following steps in the method for processing the mail data: monitoring an operating behavior regarding a mail carrying a web page link in a target mailbox, so as to obtain operating behavior data; determining a mail sending policy according to the operating behavior data, wherein the mail sending policy is a pre-created policy for sending the mail; and sending the mail carrying the web page link for mail promotion to the target mailbox based on the mail sending policy.

Alternatively, the computer terminal may include: one or more processors, memories and transmission devices.

Herein, the memory may be configured to store a software program and a module such as a program instruction/module corresponding to the rule matching method and device in the embodiment of the disclosure, and the processor executes various function applications and data processing by operating the software program and the module stored in the memory, namely implementing the above-mentioned rule matching method. The memory may include a high-speed random access memory, and may further include a nonvolatile memory such as one or more magnetic storage devices, flash memories or other nonvolatile solid state memories. In some examples, the memory may further include memories remote from the processor, wherein these remote memories may be connected to a terminal via a network. The network examples include, but not limited to, internet, intranet, a local area network, a mobile communication network and combinations.

The transmission device is configured to receive or transmit data via a network. The specific network examples may include a cable network and a radio network. In an example, the transmission device includes a Network Interface Controller (NIC), which may be connected with other network equipment and routers via a network cable so as to communicate with the internet or local area network. In an example, the transmission device is a Radio Frequency (RF) module, configured to communicate with the internet in a radio manner.

Herein, specifically, the memory is configured to store information about a preset action condition and a preset right user, and an application program.

The processor may call the information and the application program stored by the memory via the transmission device, so as to execute program codes of the method steps in each alternative or preferred embodiment in the above-mentioned method embodiments.

Those of ordinary skill in the art may understand that the computer terminal may be terminal equipment such as a smart phone (Android phone, iOS phone or the like), a tablet computer, a palmtop, MIDs and a PAD.

Those of ordinary skill in the art may understand that all or some steps in various methods of the above-mentioned embodiments may be completed by instructing relevant hardware of terminal equipment via a program, the program may be stored in a computer-readable storage medium, and the storage medium may include: a flash disk, a Read-Only Memory (ROM), a Random Access Memory (RAM), a magnetic disk or an optical disk.

The embodiment of the disclosure also provides a storage medium. Alternatively, in the present embodiment, the storage medium may be configured to store program codes for executing the method for processing the mail data provided by the above-mentioned method embodiments and device embodiments.

Alternatively, in the present embodiment, the storage medium may be located in any one computer terminal in a computer terminal group in a computer network, or in any one mobile terminal in a mobile terminal group.

Alternatively, in the present embodiment, the storage medium is configured to store program codes for executing the following steps: monitoring an operating behavior regarding a mail carrying a web page link in a target mailbox, so as to obtain operating behavior data; determining a mail sending policy according to the operating behavior data, wherein the mail sending policy is a pre-created policy for sending the mail; and sending the mail carrying the web page link for mail promotion to the target mailbox based on the mail sending policy.

Alternatively, in the present embodiment, the storage medium may also be configured to store program codes of various preferred or alternative method steps provided by the method for processing the mail data.

The method for processing the mail data and device according to the disclosure are described as above in an example manner with reference to the drawings. However, those skilled in the art should understand that various improvements may also be made on the method for processing the mail data and device provided by the disclosure without departing from the content of the disclosure. Therefore, the scope of protection of the disclosure should be determined by the content of the appended claims.

The device for processing the mail data includes a processor and a memory. The monitoring unit 10, the first determination unit 20, the sending unit 30 and other units are stored in the memory by serving as program units. The above-mentioned program units stored in the memory are executed by the processor. The mail sending policy may be stored in the memory.

The processor contains a kernel, which calls a corresponding program unit from the memory. There may be one or more kernels, and a mail is sent by adjusting kernel parameters.

The memory may include a volatile memory, an RAM and/or a non-volatile memory in a computer-readable medium such as an ROM or a flash RAM, the memory including at least one storage chip.

The present disclosure also provides a computer program product. When being executed on data processing equipment, the computer program product is suitable for executing program codes initializing the following method steps: monitoring an operating behavior regarding a mail carrying a web page link in a target mailbox, so as to obtain operating behavior data; determining a mail sending policy according to the operating behavior data, wherein the mail sending policy is a pre-created policy for sending the mail; and sending the mail carrying the web page link for mail promotion to the target mailbox based on the mail sending policy.

The serial numbers of the embodiments of the present disclosure are only used for descriptions, and do not represent the preference of the embodiments.

In the above-mentioned embodiments of the present disclosure, descriptions for each embodiment are emphasized respectively, and parts which are not elaborated in a certain embodiment may refer to relevant descriptions for other embodiments.

In several embodiments provided by the present disclosure, it will be appreciated that the disclosed device may be implemented in another manner. For example, the device embodiment described above is only schematic. For example, division of the units is only logic function division, and other division manners may be adopted during practical implementation. For example, multiple units or components may be combined or integrated into another system, or some characteristics may be neglected or not executed. In addition, coupling or direct coupling or communication connection between displayed or discussed components may be indirect coupling or communication connection, implemented through some interfaces, of the units or the modules, and may be electrical and mechanical or adopt other forms.

The above-mentioned units described as separate parts may or may not be physically separated, and parts displayed as units may or may not be physical units, and namely may be located in the same place, or may also be distributed to multiple network units. Part or all of the units may be selected to achieve the purpose of the solutions of the present embodiment according to a practical requirement.

In addition, each function unit in each embodiment of the present disclosure may be integrated into a processing unit, each unit may also exist independently, and two or more than two units may also be integrated into a unit. The above-mentioned integrated unit may be implemented in a form of hardware, and may also be implemented in a form of software function unit.

When being implemented in a form of software function unit and sold or used as an independent product, the integrated unit may be stored in a computer-readable storage medium. Based on such understanding, the essence of the technical solutions of the present disclosure or parts making contributions to the related art may be embodied in form of software product, and the computer software product is stored in a storage medium, including a plurality of instructions used to enable computer equipment (which may be a personal computer, a server, network equipment or the like) to execute all or part of the method in each embodiment of the present disclosure. The foregoing storage medium includes: various media capable of storing program codes such as a U disk, an ROM, an RAM, a mobile hard disk, a magnetic disk or an optical disk.

The above is only preferred implementation manners of the present disclosure. It should be pointed out that those of ordinary skill in the art may also make some improvements and modifications without departing from the principle of the present disclosure. These improvements and modifications should fall within the scope of protection of the present disclosure.

What is claimed is:

1. A method for processing mail data, comprising:
monitoring an operating behavior regarding a mail carrying a web page link in a target mailbox, as to obtain operating behavior data;
determining a mail sending policy according to the operating behavior data, wherein the mail sending policy is a pre-created policy for sending a mail; and
sending a mail carrying a web page link for mail promotion to the target mailbox according to the mail sending policy.

2. The method as claimed in claim 1, further comprising:
acquiring an identification parameter, carried in the web page link, for identifying the target mailbox;
associating the operating behavior data with the target mailbox by utilizing the identification parameter, and establishing an association relationship;
acquiring user information corresponding to the target mailbox; and
classifying the operating behavior data according to the user information, and analyzing a conversion result of the mail promotion on a user group.

3. The method as claimed in claim 1, further comprising:
determining the operating behavior regarding the mail carrying the web page link in the target mailbox, wherein
determining the operating behavior regarding the mail carrying the web page link in the target mailbox comprises:
monitoring whether a preset request is received, wherein when the mail is opened, the preset request is sent to request for a hidden picture pre-added into the mail; and
when the preset request is monitored, determining the operating behavior, wherein the operating behavior at least comprises: an operation of opening the mail carrying the web page link in the target mailbox, and an operation of clicking the web page link in the mail carrying the web page link in the target mailbox.

4. The method as claimed in claim 1, wherein after sending the mail carrying the web page link for mail promotion to the target mailbox according to the mail sending policy, the method further comprising:
monitoring an operating behavior regarding the mail carrying the web page link for the mail promotion, as to obtain operating behavior data regarding the mail carrying the web page link for the mail promotion;
updating the mail sending policy according to the operating behavior data; and
sending the mail carrying a web page link for mail promotion to the target mailbox according to the updated mail sending policy.

5. The method as claimed in claim 4, wherein determining the mail sending policy according to the operating behavior data comprises:
selecting a first sending policy when the mail is opened but the web page link is not clicked, wherein the first sending policy is: sending a content-adjusted mail to the target mailbox; and
selecting a second sending policy when the web page link is clicked but not to jump to a web page, wherein the second sending policy is: re-sending the mail to the target mailbox, wherein
sending the mail carrying the web page link for mail promotion to the target mailbox according to the updated mail sending policy comprises: adjusting content of the mail; and sending a content-adjusted mail to the target mailbox.

6. A device for processing mail data, comprising:
a monitoring unit, configured to monitor an operating behavior regarding a mail carrying a web page link in a target mailbox, so as to obtain operating behavior data;
a first determination unit, configured to determine a mail sending policy according to the operating behavior data, wherein the mail sending policy is a pre-created policy for sending a mail; and
a sending unit, configured to send a mail carrying a web page link for mail promotion to the target mailbox according to the mail sending policy.

7. The device as claimed in claim 6, further comprising:
a first acquisition unit, configured to acquire an identification parameter, carried in the web page link, for identifying the target mailbox;
an association unit, configured to associate the operating behavior data with the target mailbox by utilizing the identification parameter, and establish an association relationship;
a second acquisition unit, configured to acquire user information corresponding to the target mailbox; and
an analysis unit, configured to classify the operating behavior data according to the user information, and analyze a conversion result of mail promotion on a user group.

8. The device as claimed in claim 6, further comprising:
a second determination unit, configured to determine the operating behavior regarding the mail carrying the web page link in the target mailbox,
wherein the second determination unit comprises:
a monitoring module, configured to monitor whether a preset request is received, wherein when the mail is opened, the preset request is sent to request for a hidden picture pre-added into the mail; and
a determination module, configured to determine the operating behavior when the preset request is monitored, wherein the operating behavior at least comprises: an operation of opening the mail carrying the web page link in the target mailbox, and an operation of clicking the web page link in the mail carrying the web page link in the target mailbox.

9. The device as claimed in claim 7, wherein
the monitoring unit is further configured to monitor, after sending the mail carrying the web page link for mail promotion to the target mailbox according to the mail sending policy, an operating behavior regarding the mail carrying the web page link for mail promotion, so as to obtain operating behavior data regarding the mail carrying the web page link for mail promotion;
the first determination unit is further configured to update the mail sending policy according to the operating behavior data; and
the sending unit is further configured to send the mail carrying a web page link for mail promotion to the target mailbox according to the updated mail sending policy.

10. The device as claimed in claim 9, wherein
the first determination unit comprises: a first selection module, configured to select a first sending policy when the mail is opened but the web page link is not clicked, wherein the first sending policy is: sending a content-adjusted mail to the target mailbox; and a second selection module, configured to select a second sending policy when the web page link is clicked but not to jump to a web page, wherein the second sending policy is: re-sending the mail to the target mailbox; and
the sending unit comprises: an adjustment module, configured to adjust content of the mail; and a sending module, configured to send a content-adjusted mail to the target mailbox.
